(19) United States
(12) Patent Application Publication
(10) Pub. No.: US 2021/0174198 A1
(43) Pub. Date: Jun. 10, 2021

(54) COMPOUND NEURAL NETWORK ARCHITECTURE FOR STRESS DISTRIBUTION PREDICTION

(71) Applicant: GM GLOBAL TECHNOLOGY OPERATIONS LLC, Detroit, MI (US)

(72) Inventors: Epaphroditus Rajasekhar Nicodemus, Bengaluru (IN); Sudipto Ray, Seegehalli (IN)

(21) Appl. No.: 16/709,333

(22) Filed: Dec. 10, 2019

(51) Int. Cl. G06N 3/08; G06N 3/04

(52) U.S. Cl. CPC G06N 3/08; G06N 3/0454

(57) ABSTRACT

A neural network architecture and a method for determining a stress of a structure. The neural network architecture includes a first neural network and a second neural network. A neuron of last hidden layer of the first neural network is connected to a neuron of a last hidden layer of the second neural network. A first data set is input into the first neural network. A second data set is input into the second neural network. Data from the last hidden layer of the first neural network is combined with data from the last hidden layer of the second neural network. The stress of the structure is determined from the combined data.

### INTRODUCTION

The subject disclosure relates to a neural network architecture for use in quickly and accurately predicting the stress or any other numerical analysis or measured output such as displacement, strain, temperature, magnetic flux, etc. in solid structures subjected to mechanical, thermal, electromagnetic or any other type of loads and, in particular, to a neural network architecture for predicting stress patterns in load bearing structural components.

FEA (Finite Element Analysis) is a numerical analysis technique used amongst structural analysis engineers to compute the stress distribution in a structure and look for possible failure locations. The von-Mises stress can be compared to the yield strength of the material to assess failure. Also, failure can be assessed by comparing various stress parameters such as maximum principle stress, maximum shear stress, maximum varying stress or any combination of stress parameters, etc. with material properties such as yield strength, ultimate strength, endurance limit, or a combination of material properties. FEA analysis process is time consuming for complex structures due to the inherent workflow involving meshing the structure and solving the governing differential equations.

Machine learning techniques, instead, offer a fast and accurate surrogate of FEA for stress analysis which can be used for quickly exploring and optimizing design space. However, for three-dimensional structures, machine learning surrogate models for predicting stress patterns are not practical because of the complexity of the physics and the amount of simulation data required to adequately capture the complex stress patterns and its relationship with input parameters. Accordingly, it is desirable to provide a machine learning architecture that can predict stress efficiently in three-dimensional structures.

### SUMMARY

In one exemplary embodiment, a method of determining a stress of a structure is disclosed. A first data set is input into a first neural network. A second data set is input into a second neural network. Data from a last hidden layer of the first neural network is combined with data from a last hidden layer of the second neural network. The stress of the structure is determined from the combined data.

In addition to one or more of the features described herein, combining the data further includes combining data from an i^{th} neuron of the last hidden layer of the first neural network with data from an i^{th} neuron of the last hidden layer of the second neural network. Combining the data further includes at least one of a scalar mathematical operation and/or a matrix operation. In various embodiments, a third data set is input into a third neural network and data from the last hidden layer of the first neural network is combined with data from the last hidden layer of the second neural network and data from the last hidden layer of the third neural network. The method further includes obtaining the stress for the structure, splitting the stress into a first stress component that is a function of spatial coordinates and a second stress component that is a function of geometry and loading, and inputting the first stress inputs into the first neural network and the second stress inputs into the second neural network. The first data set and the second data set are one of intersecting data sets and non-intersecting data sets. The structure can be loaded by at least one of a mechanical load, a thermal load, and an electromagnetic load. The method further includes determining at least one of a strain of the structure, a displacement of the structure, a temperature of the structure, a heat flux of the structure, a magnetic flux of the structure, a numerical analysis of the structure, and a measured output of the structure. In various embodiments, one of the first data set and the second data set is an image or video data set and the other of the first data set and the second data set is measurement or numerical data set. In various embodiments, at least one of the first neural network and the second neural network is at least one of a convolution neural network (CNN), an artificial neural network (ANN) and a recurrent neural network (RNN). The stress of the structure is determined from one of a single output and a plurality of outputs.

In another exemplary embodiment, a neural network architecture for determining a stress of a structure is disclosed. The neural network architecture includes a first neural network configured to receive a first data set of the structure and a second neural network configured to receive a second data set of the structure. A neuron of last hidden layer of the first neural network is connected to a neuron of a last hidden layer of the second neural network in order to combine data from the respective neurons to determine the stress of the structure.

In addition to one or more of the features described herein, an i^{th} neuron of the last hidden layer of the first neural network is connected to an i^{th} neuron of the last hidden layer of the second neural network. The neuron of last hidden layer of the first neural network is connected to the neuron of the last hidden layer of the second neural network to enable at least one of a scalar mathematical operation and/or a matrix operation of the data of the respective neurons. In one embodiment, the first data set of the structure is a function of coordinates and the second data set of the structure that is a function of geometry and loading. The first data set and the second data set are one of intersecting data sets and non-intersecting data sets. The structure can be loaded by at least one of a mechanical load, a thermal load, and an electromagnetic load. One of the first data set and the second data set is an image or video data set and the other of the first data set and the second data set is a measurement or numerical data set. In various embodiments, at least one of the first neural network and the second neural network is at least one of a convolution neural network (CNN), an artificial neural network (ANN) and a recurrent neural network (RNN). The combined data is provided as one of a single output and a plurality of outputs.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a neural network architecture for determining stress of a structural component;

FIG. 2 shows an illustrative operation of a neuron of a neural network;

FIG. 3 shows illustrations of different activation functions generally used in a neural network;

FIG. 4 illustrates a procedure to estimate parameters such as weights and biases of the neural network architecture;

FIG. 5 illustrates a finite element method for stress computation;

FIG. 6 shows an example of geometric parameters of an illustrative structure under loading;

FIG. 7 illustrates an operation of the neural network architecture for a one-dimensional case;

FIG. 8 illustrates heuristic/working the neural network architecture for a one-dimensional case for an object made of two separate cross-sections: a first cross-section and a second cross-section;

FIG. 9 shows a comparison between Finite Element Analysis (FEA) computed stress and stress predicted using the neural network architecture of FIG. 1; and

FIG. 10 shows a flowchart for developing the neural network architecture disclosed herein.

### DETAILED DESCRIPTION

The following description is merely exemplary in nature and is not intended to limit the present disclosure, its application or uses. It should be understood that throughout the drawings, corresponding reference numerals indicate like or corresponding parts and features.

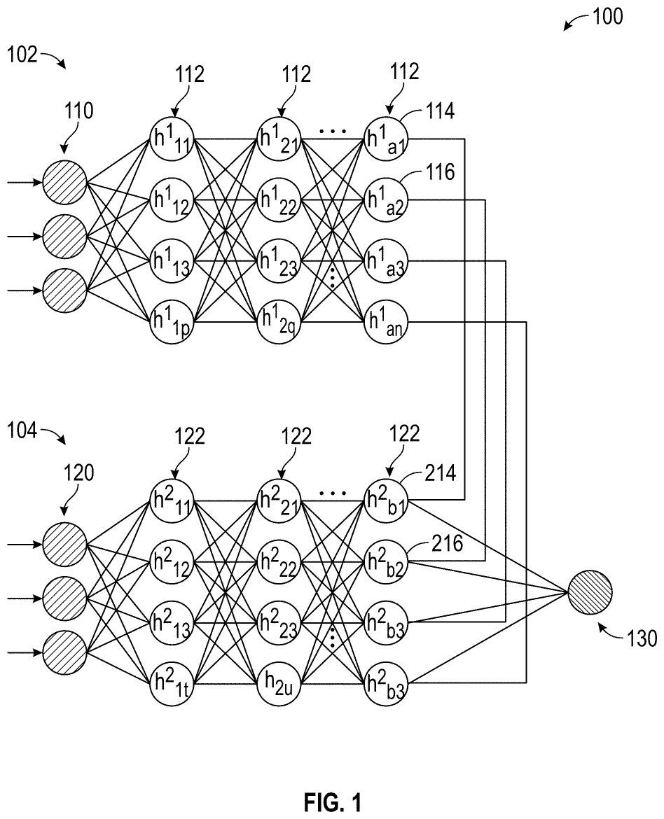

In accordance with an exemplary embodiment, FIG. 1 shows a neural network architecture 100 for determining a stress distribution of a structural component. The neural network architecture 100 includes a first neural network 102 and a second neural network 104 coupled to the first neural network 102. The first neural network 102 includes an input layer 110 and a plurality of hidden layers 112. For the illustrative first neural network 102, the input layer 110 includes three input neurons and the plurality of hidden layers 112 includes ‘a’ hidden layers, each hidden layer including a selected number of neurons. The second neural network 104 includes an input layer 120 and a plurality of hidden layers 122. For the illustrative second neural network 102, the input layer 120 includes three input neurons and the plurality of hidden layers 122 includes ‘b’ hidden layers, each hidden layer including a selected number of neurons. In both the first neural network 102 and the second neural network 104, the number of neurons in one hidden layer need not be the same as the number of neurons in another hidden layer.

In operation, the input data for structural component stress prediction can be split into two data sets. In one embodiment, the first set of data includes spatial coordinates and the second set of data includes inputs pertaining to geometric parameters (of the structural part), loads/boundary conditions, and material properties. The first set of data is input to the first neural network 102 and the second set of data is input to the second neural network 104.

The first neural network 102 is combined with the second neural network 104 via end-to-end neuron addition. In one embodiment, the output from the last hidden layer of the first neural network is combined with the output from the last hidden layer of the second neural network in order to calculate an output parameter, such as a stress on the structural component. It is to be understood that the output in general can be any parameter from FEA solutions such as stress, strain, displacement, temperature, magnetic flux, etc.

In end-to-end neuron addition, as shown in FIG. 1, output from the first neuron 114 of the last hidden layer of the first neural network 102 is combined with output from the first neuron 214 of the last hidden layer of the second neural network 104. Output from the second neuron 116 of the last hidden layer of the first neural network 102 is combined with output from the second neuron 216 of the last hidden layer of the second neural network 104, and so forth. In general, output from the n^{th} neuron of the last hidden layer of the first neural network 102 is combined with output from the n^{th} neuron of the last hidden layer of the second neural network 104. The above-mentioned neuron outputs can be combined by any suitable mathematical operation, such as, but not limited to, addition, subtraction, multiplication, division, matrix addition, matrix subtraction, matrix multiplication, matrix division, etc.

It is to be understood that the neural network architecture 100 can include more than two neural networks with the set of input data being divided amongst the more than two neural networks according to a selected guideline or procedure based on physical laws or other criteria. For more than two neural networks, the end-to-end neural addition includes combining the outputs from first neuron of the last hidden layers of the neural networks, combining the outputs from second neuron of the last hidden layers, etc.

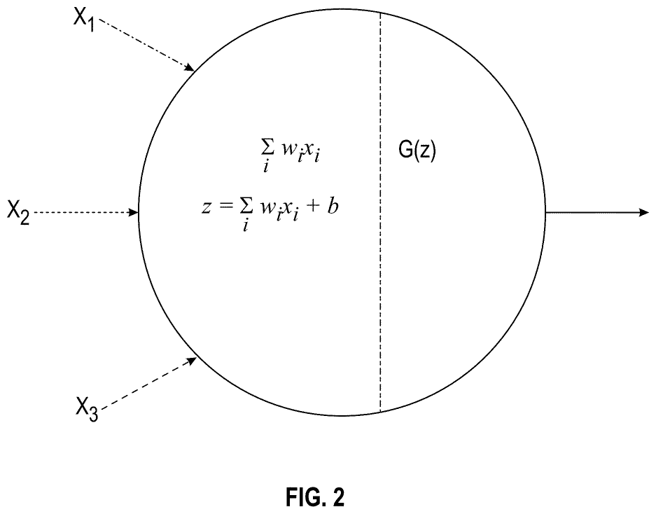

FIG. 2 shows an illustrative operation of a neuron of a neural network. The neuron receives a plurality of input {x1, x2, x3} along their respective connections. Each connection has an associated weight coefficient. The neuron multiplies each input by its associated weight coefficient and performs a linear combination, i.e.:

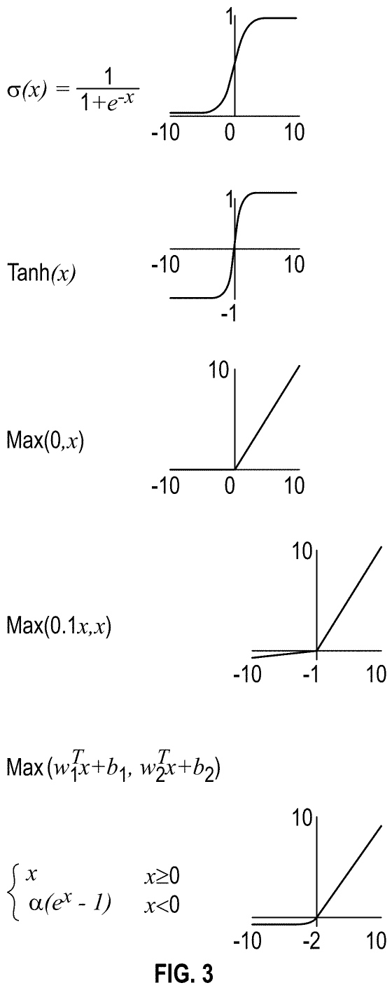

z=Σᵢwᵢxᵢ+b Eq. (1)

where wᵢ is a weight coefficient and b s a bias term. The summation results in a scalar value z. The neuron then activates the scalar value using an activation function G(z), presenting the scalar value z as input to a subsequent neuron. Some illustrative activation functions for use in a neural network are shown in FIG. 3.

For a neural network architecture 100 having k neural networks that are combined via end-to-end neuron addition, the output 130 of the neural network architecture 100 can described as in shown in Eq. (2):

output(y₁ₓ₁)=Wₙₓ₁^{T}(Σᵢ₌₁^{k}hₙₓ₁ⁱ)+b₁ₓ₁ Eq. (2)

where hₙₓ₁ⁱ indicates the vector of size n consisting of the last layer of the i^{th} neural network. W^{T}ₙₓ₁ is a column vector including weight coefficients for each of the summation terms and b₁ₓ₁ is the bias term. In vector form, the summation term forms a column vector including n row (one for each neuron), each row including a summation of consisting of k terms (one term for each neural network), as in Eq. (3):

$${\sum }_{i = 1}^{k} {h}_{n x 1}^{i} = [ \begin{matrix}{h}_{a 1}^{1} + {h}_{b 1}^{2} + … {h}_{k 1}^{k} \\ {h}_{a 2}^{1} + {h}_{b 2}^{2} + … {h}_{k 2}^{k} \\ ⋮ \\ {h}_{a n}^{1} + {h}_{b n}^{2} + … {h}_{k n}^{k}\end{matrix} ] \qquad Eq . ( 3 )$$

For the illustrative neural network architecture 100 of FIG. 1 in which there are only two neural networks (k=2), the column vector of Eq. (3) reduces to the column vector of Eq. (4):

$${\sum }_{i = 1}^{k} {h}_{n x 1}^{i} = [ \begin{matrix}{h}_{a 1}^{1} + {h}_{b 1}^{2} \\ {h}_{a 2}^{1} + {h}_{b 2}^{2} \\ ⋮ \\ {h}_{a n}^{1} + {h}_{b n}^{2}\end{matrix} ] \qquad Eq . ( 4 )$$

In another embodiment of end-to-end neuron addition, the individual weight coefficients of each neuron are included in the summation term as shown in Eq. (5):

output(y₁ₓ₁)=Wₚᵣₑ_{ₙₓ₁}^{T}(Σᵢ₌₁^{k}Wₙₓ₁ⁱΘhₙₓ₁ⁱ)+b₁ₓ₁ Eq. (5)

where hₙₓ₁ⁱ indicates the vector of size n consisting of the last layer of the i^{th} neural network. Wₚᵣₑ_{ₙₓ₁}^{T} is a column vector including weight coefficients for each of the summation terms, Wₙₓ₁ⁱ is row vector including weight coefficients for each of the neuron contribution from k neural networks and b₁ₓ₁ is the bias term and Θ represents a Hadamard product. In vector form, the summation term forms a column vector including n row (one for each neuron), each row including a summation of consisting of k terms (one term for each neural network), as in Eq. (6):

$${\sum }_{i = 1}^{k} {W}_{n x 1}^{i} Θ {h}_{n x 1}^{i} = [ \begin{matrix}{W}_{1}^{1} {h}_{a 1}^{1} + {W}_{1}^{2} {h}_{b 1}^{2} + … {W}_{1}^{k} {h}_{k 1}^{k} \\ {W}_{2}^{1} {h}_{a 2}^{1} + {W}_{2}^{2} {h}_{b 2}^{2} + … {W}_{2}^{k} {h}_{k 2}^{k} \\ ⋮ \\ {W}_{n}^{1} {h}_{a n}^{1} + {W}_{n}^{2} {h}_{b n}^{2} + … {W}_{n}^{k} {h}_{k n}^{k}\end{matrix} ] \qquad Eq . ( 6 )$$

For only two neural networks (k=2), the column vector of Eq. (6) reduces to

$${\sum }_{i = 1}^{k} {W}_{n x 1}^{i} Θ {h}_{n x 1}^{i} = [ \begin{matrix}{W}_{1}^{1} {h}_{a 1}^{1} + {W}_{1}^{2} {h}_{b 1}^{2} \\ {W}_{2}^{1} {h}_{a 2}^{1} + {W}_{2}^{2} {h}_{b 2}^{2} \\ ⋮ \\ {W}_{n}^{1} {h}_{a 2}^{1} + {W}_{n}^{2} {h}_{b 2}^{2}\end{matrix} ] \qquad Eq . ( 7 )$$

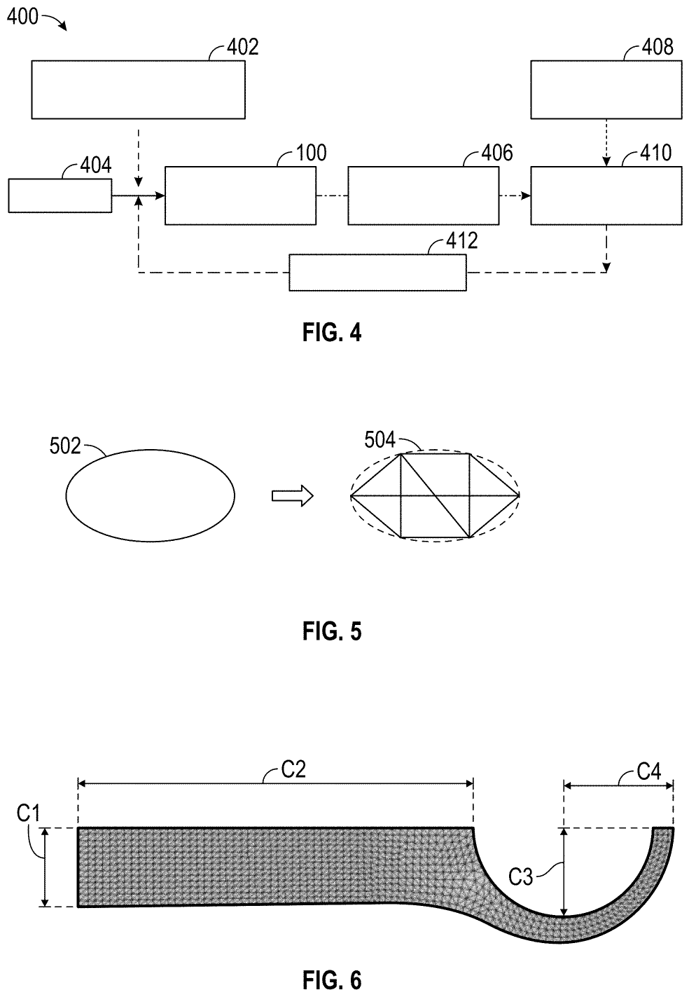

FIG. 4 shows a schematic diagram 400 illustrating a method for estimating the parameters of the neural network architecture. The neural network architecture 100 is trained over a plurality of iterations. For a first iteration, the weights (w) and biases (b) 402 of the neural network architecture 100 are initialized from uniform distribution or normal distribution or specialized initialization technique like Xavier or Hi or any other initialization can be used. The input data 404 is provided to neural network architecture 100, which uses the input data and initialized values of parameters 402 to predict an output (y) 406 corresponding to input value. This predicted value (y) 406 is typically different from actual value (y′) of output 408. An appropriate cost function 410 is identified to represent the difference between y and y′. The chosen cost function can be a mean square error or binary cross entropy or any other suitable function. An optimization algorithm based on gradient decent such as SGD (stochastic gradient decent), Nesterov accelerated gradient, AdaGrad, ADAMS or any other algorithm can be used to compute new weights and biases 412 to be used in a next iteration to reduce the cost function using user defined learning rate and other relevant user defined parameters for the selected optimization algorithm. In one embodiment, the optimization algorithm computes gradient of cost function with respect weights and biases using back propagation algorithm. The optimization algorithm is run through several iterations to minimize the cost function until a predefined stopping criterion is reached. The parameters of the neural network after the optimization/training for given data set are used for predicting output (stress) for new input data.

In one embodiment, the new weights and biases 412 can be computed by:

w_{new}=w_{old}−αΔw Eq. (8)

and

b_{new}=b_{old}−αΔb Eq. (9)

where α is user-defined learning rate.

FIG. 5 illustrates a finite element analysis (FEA) method for stress computation. A domain 502 represents a location on a structural solid part undergoing loading. The domain 502 is discretized using element and neurons as shown in 504. This discretization scheme along with numerical method like Galerkin technique can be used to reduce physics-based differential equations into algebraic equations in matrix form. These matrix equations can be solved to obtain displacements at each neuron and subsequently post-processed to obtain stress at each nodal portion (spatial positions). The nodal spatial positions obtained from the discretized mesh can be input into the first neural network 102 of the neural network architecture 100.

FIG. 6 shows an example of geometric parameters of an illustrative structural component. The geometric parameters can include a length and width of various sections of the structural component, curvatures, angles, etc. For the structural component of FIG. 6 a width C1 and length C2 are shown of a shaft section of the component. Also, a radius C3 and thickness C4 of a curved section is shown. This geometric data as well as the location and magnitude of various loads can be provided to the second neural network 104 of the neural network architecture 100.

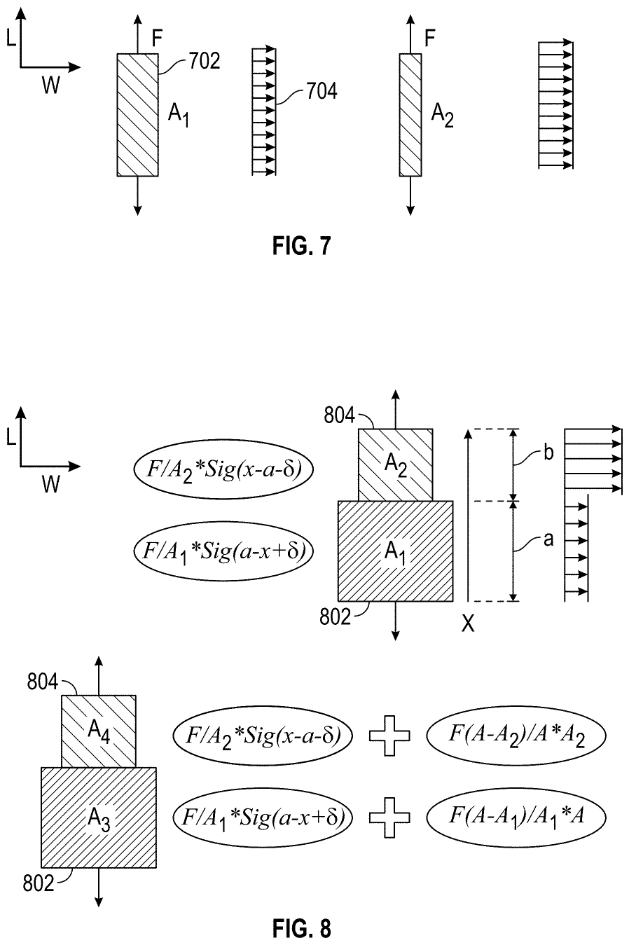

FIG. 7 illustrates an operation of the neural network architecture 100 for a one-dimensional case. The one-dimensional cases in FIG. 7 and FIG. 8 show how the stress can be physically split into two different functions with different inputs. The explanation below details examples of what functions each neural network 102 and 104 can learn when trained appropriately on data. A force F is applied along a length axis of an object 702 having a length and width. A resulting stress 704 is shown along the length axis of the object 702. For this case, the spatial coordinates (X) is input into the first neural network 102. The output function of the first neural network 102 after learning from training data is a constant which can be equated to F/A for an arbitrary area A₁ and is given by:

NN₁=σ(X)=c=F/A₁ Eq. (10)

The geometry (A) and applied force (F) is input into the second neural network. The output function of the second neural network 104 after learning from training data is given by:

NN₂=σ(A,F)=F(A₁−A)/(A*A₁) Eq. (11)

The end-to-end neural addition of the outputs of NN1 and NN2 gives a total stress as indicated in Eq. (12) for an input area A₁ and applied force (F) is:

σ=NN₁+NN₂=F/A₁ Eq. (12)

If area A₂ and applied force (F) is inputted to the neural network architecture 100 for the above one-dimensional case, the output of the first neural network 102, which is based on spatial coordinates, remains unchanged, as shown in Eq. (13):

NN₁=σ(X)=F/A₁ Eq. (13)

Meanwhile, the output of the second neural network 104 is given by:

NN₂=σ(A₂,F)=F(A₁−A₂)/(A₁*A₂) Eq. (14)

From end-to-end neural addition, the total determined stress of the deformed object is given as shown in Eq. (15):

σ=NN₁+NN₂=F/A₂ Eq. (15)

FIG. 8 shows a one-dimensional case for an object made of two separate cross-sections: a first cross-section 802 and a second cross-section 804. The first neural network 102 estimates the stress as a function of spatial coordinates (X). First neuron of the first neural network can estimate stress function for the first cross-section 802 while a second neuron estimates stress function from the second cross-section 804. The stress function estimated by a first neuron of the first network after learning from training data is given by Eq. (16)):

NN₁=c₁*Sig(a−x+δ)=F/A₁*Sig(a−x+δ) Eq. (16)

where Sig is a sigmoid function based on a length of the first area that limits the stress output to first cross-section 802 and δ is a small number as compared to values of a and b. Meanwhile, the stress function estimated by a second neuron of the first network after learning from training data is given by Eq. (17):

NN₁=c₂*Sig(x−a−δ)=F/A₂*Sig(x−a−δ) Eq. (17)

The second neural network estimates stress as a function of geometry and load. The output stress function from first neuron of the second neural network 104 after learning from training data is given by Eq. (18):

NN₂=F(A−A₁)/(A*A₁) Eq. (18)

while the output stress function from second neuron of the second neural network 104 after learning from training data is given by Eq. (19):

NN₂=F(A−A₂)/(A*A₂) Eq. (19)

If input areas of A₃ and A₄ are given as input to the neural network architecture 100 for one dimensional case with two different cross-sections. The resultant stress resulting from end-to-end neuron addition is given by Eq. (20):

σ(x)=F/A₁*Sig(a−x+δ)+F(A₃−A₁)/(A₃*A₁) Eq. (20)

or by Eq. (21):

σ(x)=F/A₂*Sig(x−a−δ)+F(A₄−A₂)/(A₃*A₂) Eq. (21)

where the stress is depending on the x value. Similar logic can be extrapolated to two-dimensional and three-dimensional solid structures.

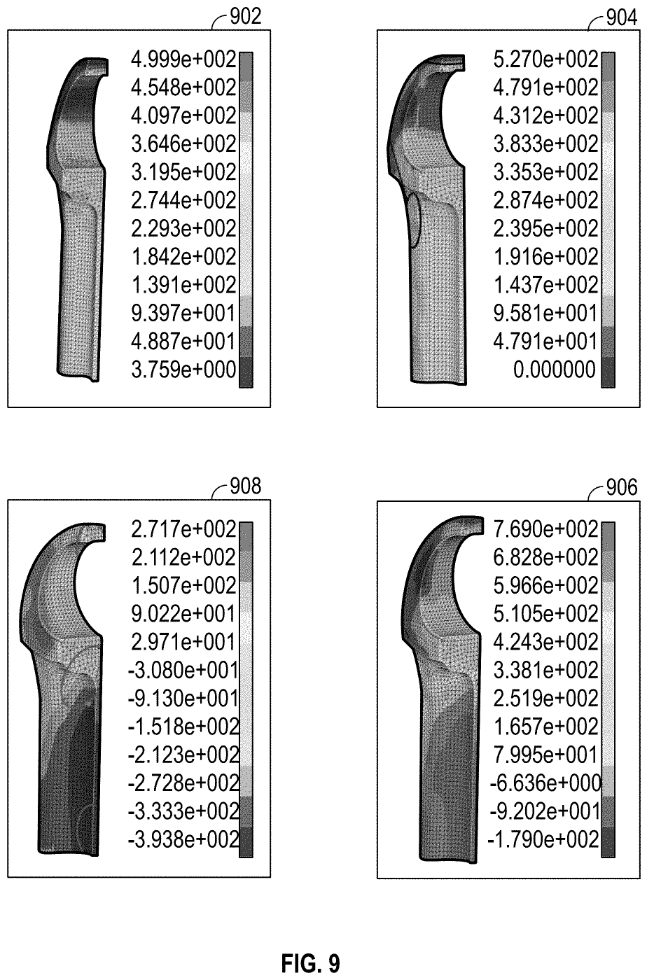

FIG. 9 shows a comparison of the stress 902 computed from FEA analysis on a component and a stress 904 predicted using the neural network architecture 100 of FIG. 1 for a connecting rod of an automobile engine. The predicted stress 904 agrees with the actual stress 902 within about a 10-15% error. Stress determined at the first neural network 102 is shown in 906, while stress determined at the second neural network 104 is shown in 908.

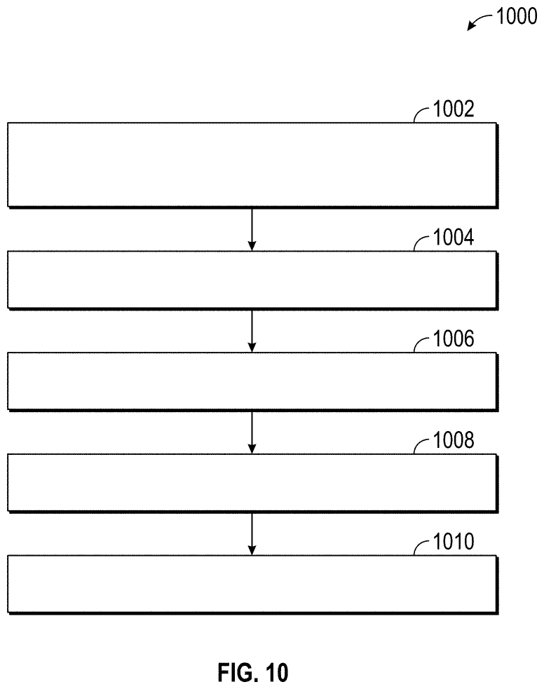

FIG. 10 shows a flowchart 1000 for developing the neural network architecture 100 disclosed herein. In box 1002, data is collected for the structural component and the data is split into input data for the first neural network (e.g., spatial co-ordinates) and input data for the second neural network (e.g., geometric parameters and loading data). In box 1004, the architecture for the first neural network is developed using the spatial coordinate input data. Developing an architecture includes determining the number of layers, number of neurons within a layer, etc. Skip/residual connections can be used if the number of hidden layers exceeds a selected number, such as five layers. Spatial coordinate input data for a single structure component can be used to train the first neural network for determining number of layers, a number of neurons within a layer, etc. for neural network 102. In box 1006, the architecture for the second neural network is developed using the geometric parameters and loading data. In box 1008, the first neural network and of the second neural network are combined using end-to-end neuron addition, as disclosed herein. In box 1010, the combined neural network architecture is validated and deployed for stress analysis.

While the neural network architecture has been discussed without specification of the types of neural networks, it is to be understood that either of the first neural network and the second neural network can be a convolution neural network (CNN), a recurrent neural network (RNN), a recurrent neural network (RNN or other suitable neural networks. Additionally, the data is not confined to stress data and can be any selected data set. The stress data can be in different from such as von-misses, maximum principal, etc. In one example, the one set of data can be image/video data while the other set of data is measurement/numeric data.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of determining a stress of a structure, comprising:
inputting a first data set into a first neural network;
inputting a second data set into a second neural network;
combining data from a last hidden layer of the first neural network with data from a last hidden layer of the second neural network; and
determining the stress of the structure from the combined data.

2. The method of claim 1, wherein combining the data further comprises combining data from an i^{th} neuron of the last hidden layer of the first neural network with data from an i^{th} neuron of the last hidden layer of the second neural network.

3. The method of claim 1, wherein combining the data further comprises at least one of a scalar mathematical operation and/or a matrix operation.

4. The method of claim 1, further comprising inputting a third data set into a third neural network and combining data from the last hidden layer of the first neural network, data from the last hidden layer of the second neural network and data from the last hidden layer of the third neural network.

5. The method of claim 1, further comprising obtaining the stress for the structure, splitting the stress into a first stress component that is a function of spatial coordinates and a second stress component that is a function of geometry and loading, and inputting the first stress inputs into the first neural network and the second stress inputs into the second neural network.

6. The method of claim 1, wherein the first data set and the second data set are one of intersecting data sets and non-intersecting data sets.

7. The method of claim 1, wherein the structure is loaded by at least one of a mechanical load, a thermal load, and an electromagnetic load.

8. The method of claim 6, further comprising determining at least one of a strain of the structure, a displacement of the structure, a temperature of the structure, a heat flux of the structure, a magnetic flux of the structure, a numerical analysis of the structure, and a measured output of the structure.

9. The method of claim 1, wherein one of the first data set and the second data set is an image or video data set and the other of the first data set and the second data set is a measurement or a numerical data set.

10. The method of claim 1, wherein at least one of the first neural network and the second neural network is at least one of a convolution neural network (CNN), an artificial neural network (ANN), and a recurrent neural network (RNN).

11. The method of claim 1, further comprising determining the stress of the structure from one of a single output and a plurality of outputs.

12. A neural network architecture for determining a stress of a structure, comprising:
a first neural network configured to receive a first data set of the structure;
a second neural network configured to receive a second data set of the structure;
wherein a neuron of last hidden layer of the first neural network is connected to a neuron of a last hidden layer of the second neural network in order to combine data from the respective neurons to determine the stress of the structure.

13. The neural network architecture of claim 12, wherein an i^{th} neuron of the last hidden layer of the first neural network is connected to an i^{th} neuron of the last hidden layer of the second neural network.

14. The neural network architecture of claim 12, wherein the neuron of the last hidden layer of the first neural network is connected to the neuron of the last hidden layer of the second neural network to enable at least one of a scalar mathematical operation and/or a matrix operation of the data of the respective neurons.

15. The neural network architecture of claim 12, wherein the first data set of the structure is a function of coordinates and the second data set of the structure is a function of geometry and loading.

16. The neural network architecture of claim 12, wherein the first data set and the second data set are one of intersecting data sets and non-intersecting data sets.

17. The neural network architecture of claim 12, wherein the structure is loaded by at least one of a mechanical load, a thermal load, and an electromagnetic load.

18. The neural network architecture of claim 12, wherein one of the first data set and the second data set is an image or video data set and the other of the first data set and the second data set is a measurement or a numerical data set.

19. The neural network architecture of claim 12, wherein at least one of the first neural network and the second neural network is at least one of a convolution neural network (CNN), an artificial neural network (ANN) and a recurrent neural network (RNN).

20. The neural network architecture of claim 12, wherein the combined data is provided as one of a single output and a plurality of outputs.
